(19) United States
(12) Patent Application Publication
(10) Pub. No.: US 2015/0317761 A1
(43) Pub. Date: Nov. 5, 2015

(54) FLIGHT INFORMATION SYSTEM AND METHOD FOR PROCESSING SIGNAL THEREOF

(71) Applicant: LG ELECTRONICS INC., Seoul (KR)

(72) Inventors: Youngjun LEE, Pyeongtaek-si (KR); Sangheon OH, Pyeongtaek-si (KR); Sangwoon SUH, Pyeongtaek-si (KR); Andrew Iue CHEN, SAN FRANCISCO, CA (US)

(73) Assignee: LG ELECTRONICS INC., Seoul (KR)

(21) Appl. No.: 14/652,724

(22) PCT Filed: Dec. 17, 2012
(86) PCT No.: PCT/KR2012/011026

§ 371 Date: Jun. 16, 2015

(51) Int. Cl. G06Q 50/30; G06Q 10/02

(52) U.S. Cl. CPC G06Q 50/30; G06Q 10/02

(57) ABSTRACT

Disclosed are a system and method for providing flight information. A system for providing flight information according to one embodiment comprises a control unit identifying an airport user, controlling to generate and provide flight information to the identified airport user, receiving a predetermined item or an information request signal within the provided flight information, and controlling a processing corresponding to the received item or information request signal, and an information providing device outputting the flight information and processed results corresponding to the request signal, wherein the control unit controls to provide flight information including visual information respective to entry and departure and airplane flight information linked to the visual information in at least one format of a map, a graph, and a three-dimensional (3D) display, and wherein the information providing device includes at least one of a mobile device of the identified airport user and a previously installed in-airport display device.

### FIELD OF THE INVENTION

The present invention relates to a flight information system and a method for processing a signal thereof, and most particularly, to a flight information system and a method for processing a signal thereof for convenience in using an airport.

### BACKGROUND ART

In the past, in places used by a large number of people at the same time, such as airports, train stations, bus terminals, and so on, information was generally provided through analog-type information bulletin boards or Light Emitting Diode (LED) electronic panels.

However, in case of using analog-type bulletin boards, it was difficult to provide additional data other than pre-arranged data, and, moreover, since it was difficult to differentiate a predetermined set of data from other sets of data, users experienced difficulty in easily acquiring or intuitively recognizing their requested data.

Meanwhile, unlike the bulletin board, the LED electronic panel was capable of providing additional data or differentiating data to a predetermined level. However, such LED electronic panel had its limitation in providing information limited only to text-form information due to its instrumental limitations and limitations in data embodiment. And, therefore, just as the bulletin board, the LED electronic panel had its shortcomings in enabling users to easily acquiring or intuitively recognizing their requested data.

### DETAILED DESCRIPTION OF THE INVENTION

### Technical Objects

With the recent evolution in the digital industry, interest and evolution in display devices and, most particularly, large-sized display devices have become outstanding.

The conventional display device was used within limited boundaries, such as household appliances for providing broadcast programs or video content, or for personal usages, such as monitors for Personal Computers (PCs). Recently, however, large-sized display devices are attempted to be applied and used in public facilities and throughout the related industry, and the range of its field of application and usage has actually been expanding.

For example, in case of an airport, an uncountable number of users are using the airport for the purpose of entering and departing a country, and, for this, the airport is required to provide diverse flight information, such as airplane flight information, entry and departure information, as well as air freight information, and so on, to a massive number of airport users at the same time or all at once. However, as described above, due to the limitations in bulletin boards or LED electronic panels, such display devices are intended to be used. However, in this case, this situation cannot be resolved at once by simply using a large-sized display device that is proportional to the information size that is to be provided, or by increasing the resolution of the display device.

In other words, each individual airport user wishes to be provided with the information he (or she) has requested in a format that is distinguished from the abundant information provided by the airport, and also wishes to be capable of easily and intuitively recognizing his (or her) information. Accordingly, although the installation of large-sized display devices and the enhancement of their resolution are also required, it will also be crucial to determine how to configure and provide flight information to the users along with such installation and enhancement.

Accordingly, in this disclosure, as an object according to the present invention, the present invention intends to accurately and intuitively provide flight information to airport users in real-time.

As another object according to the present invention, by providing map information along with the flight information based map or position information, the present invention intends to allow airport users to efficiently use a maximum amount of time and space within the airport.

As yet another object according to the present invention, by providing flight information and map information, the present invention intends to prevent airport users from experiencing unnecessary complicated procedures within the airport upon their departure or arrival as much as possible.

As a further object according to the present invention, by improving the level of satisfaction is using the airport, the present invention intends realize an indirect effect of promoting airport sales revenue by improving the airport impression (or image) and by increasing advertisement effect targeting the airport users.

### TECHNICAL SOLUTIONS

An example of a system for providing flight information, which is disclosed in this disclosure, includes a control unit identifying an airport user, controlling to generate and provide flight information to the identified airport user, receiving a predetermined item or an information request signal within the provided flight information, and controlling a processing corresponding to the received item or information request signal, and an information providing device outputting the flight information and processed results corresponding to the request signal, wherein the control unit controls to provide flight information including visual information respective to entry and departure and airplane flight information linked to the visual information in at least one format of a map, a graph, and a three-dimensional (3D) display, and wherein the information providing device includes at least one of a mobile device of the identified airport user and a previously installed in-airport display device.

An example of a method for providing flight information, which is disclosed in this disclosure, includes identifying an airport user, generating flight information for the identified airport user and outputting the generated information through an information providing device, receiving a predetermined item or an information request signal within the provided flight information, and outputting a processed result in accordance with the received item or information request signal through the information providing device, wherein the flight information provides visual information respective to entry and departure and airplane flight information linked to the visual information in at least one format of a map, a graph, and a three-dimensional (3D) display, and wherein the information providing device includes at least one of a mobile device of the identified air user and a previously installed in-airport display device.

### Effects of the Invention

According to the present invention,

First of all, the present invention has an advantageous effect of accurately and intuitively providing flight information to airport users in real-time.

Secondly, by providing map information along with the flight information based map or position information, the present invention has an advantageous effect of allowing airport users to efficiently use a maximum amount of time and space within the airport.

Thirdly, by providing flight information and map information, the present invention has an advantageous effect of preventing airport users from experiencing unnecessary complicated procedures within the airport upon their departure or arrival as much as possible.

Fourthly, by improving the level of satisfaction is using the airport, the present invention has an advantageous effect of realizing an indirect effect of promoting airport sales revenue by improving the airport impression (or image) and by increasing advertisement effect targeting the airport users.

### BRIEF DESCRIPTION OF THE DRAWINGS

FIG. 1 illustrates a block view showing a structure of a digital system, i.e., a system for providing flight information;

FIGS. 2 and 3 illustrate exemplary embodiments showing configurations of user entry and exit gates in an airport;

FIGS. 4 to 7 illustrate exemplary embodiments of flight information configuration;

FIGS. 8 to 21 illustrate diverse exemplary embodiments of flight information usage scenarios; and

FIG. 22 illustrates an exemplary flow chart for describing a signal processing method for processing air freight within an information providing system.

### BEST MODE FOR CARRYING OUT THE PRESENT INVENTION

The present invention will hereinafter be described in detail with reference to the accompanying drawings.

The suffixes “module” and “unit” that are mentioned in the elements used to describe the present invention are merely used for the purpose of simplifying the description of the present invention. Therefore, the suffixes “module” and “unit” that are mentioned in the elements used in this disclosure are merely used individually or in combination for the purpose of simplifying the description of the present invention.

Additionally, general terms that are currently most broadly used have been used based upon the functions presented in the present invention. However, such terms may be varied in accordance with the intentions of anyone skilled in the art, general practice, or an advent of a new technology. Additionally, in some specific cases, some of the terms used herein have been arbitrarily selected by the applicant, and, in this case, the significance of such terms will be described in detail in the corresponding part of the detailed description. Accordingly, the terms used in this disclosure should be understood by its literal meaning defined in a dictionary, or should be interpreted based upon the overall context of a phrase, sentence, or paragraph of the disclosure.

Hereinafter, diverse exemplary embodiments will be described with reference to the accompanying drawings and to the description of the accompanying drawings.

However, the description of the disclosure and the content described in the drawing are merely exemplary and, therefore, will not be used to limit the present invention. And, it will be apparent that the scope and spirit of the present invention shall be decided by the appended claims of this disclosure.

The term “display device”, which is described in this disclosure, collectively refers to all types of display devices that can output diverse information, which is being transmitted from a server, into video/image formats (audio also included in some cases). Meanwhile, as described above, the server may refer to a digital system or a control unit included in a digital system, and the server may also include an external server and may also include all types of digital devices that can transmit data or information to the display device.

Although it is simply referred to as a display device in this disclosure, its position, size, form, and so on, may diversely vary in accordance with the location, purpose, and/or intention to which the information is provided, and the display device may also be referred to as a digital signage.

The display device may support computing functions, and, by being connected to at least one external input, the display device may also support such input. And, the display device may be equipped with an interface, which is for supporting an inputting means, such as a touch-screen or a mobile device.

Moreover, the display device may operate an application by using a standardized OS (Operating System), and addition, deletion, correction, and updating may also be carried out. Additionally, the display device may recommend or advise the downloading of an application to an external device, such as a mobile device, which is connected to the display device, and, in accordance with the respective selection, the corresponding application may be directly downloaded or downloaded through a server in the external device. For example, the application may correspond to a program being configured to allow all flight information that is available within the airport to be outputted, used, selected, and/or accessed. Herein, the external device can include diverse types of digital devices, such as a mobile device or a handheld device including a PDA (Personal Digital Assistant), a Smart Phone, a Tablet PC, a notebook (laptop), and so on, and, the external device also includes a mobile device that is registered in advance by the airport and then rented to airport users. In case of the latter mobile device, the above-described application may be installed to the mobile device in advance, so as to allow the airport user to easily access flight information.

Hereinafter, in order to facilitate the understanding of the technical scope and spirit of the present invention, and for the convenience in the description of the present invention, the digital system will be given as an example of a flight information system or flight information providing system, which provides flight information to airport users. However, the present invention will not be limited only to the terms used herein. And, it should be understood that the scope of the claims of the present invention shall be decided based upon the function or configuration of such terms. Additionally, it should also be understood that the present invention will not be limited only to airports. For example, the present invention shall be used and applied to all types of digital system that can provide a large amount of diverse and complicated information to users all at one or at the same time, in train stations, bus terminals, and so on, which provide a similar environment and perform a similar function as the airport, so that the users can accurately and intuitively recognize the provided information.

As described above, in airports, there is a large amount of content, i.e., flight information that should be provided, such as plane schedule information (airplane flight information), departure/entry information, air freight information, and so on. However, information that is requested by the user cannot be easily provided or intuitively recognized by simply using a large-sized display device that is proportional to the information size that is to be provided, or by increasing the resolution of the display device. Moreover, the installation of such large-sized display devices may lead to problems of cost and efficiency, which should be taken into consideration. Accordingly, it will be difficult to consider such resolution as a fundamental solution for resolving the above-described problems.

Accordingly, as described in this disclosure, essential factor relates to how to configure the flight information, which is being provided through the display device, and how to provide such information, in order to enhance user convenience, so as to allow the users to easily and intuitively gain the requested information.

In order to resolve the above-described problems, diverse exemplary embodiments will be presented herein, which will be described in detail later on.

Meanwhile, the diverse exemplary embodiments that are described in this disclosure are being proposed in order allow the users of the airport to recognize and gain flight information (airport information) more easily and conveniently and more intuitively while there are staying at the airport, and in order to maximize the efficiency in time and space, which are used during the process of using the airport, based upon the flight information.

For example, in this disclosure, in order to facilitate the airport users to access and understand flight information and to conveniently and intuitively recognize the provided information, a map or location information based map information is provided along with the flight information, and in accordance with the users' selection, diverse related information or supplemental information may be provided to the users, so as to prevent the users from experiencing unnecessary complications, and to allow the users to efficiently use their time and space in accordance with their purpose and intentions of using the airport facilities. Accordingly, by enhancing the level of satisfaction in using the airport and improving the overall airport image, and by reducing the users discomfort related to advertisement information, and, thus, the present invention may also have an indirect advantageous effect of promoting airport sales revenue in accordance with the improved advertisement effect. And, the exemplary embodiments of the present invention have been devised and disclosed in order to realize such advantages.

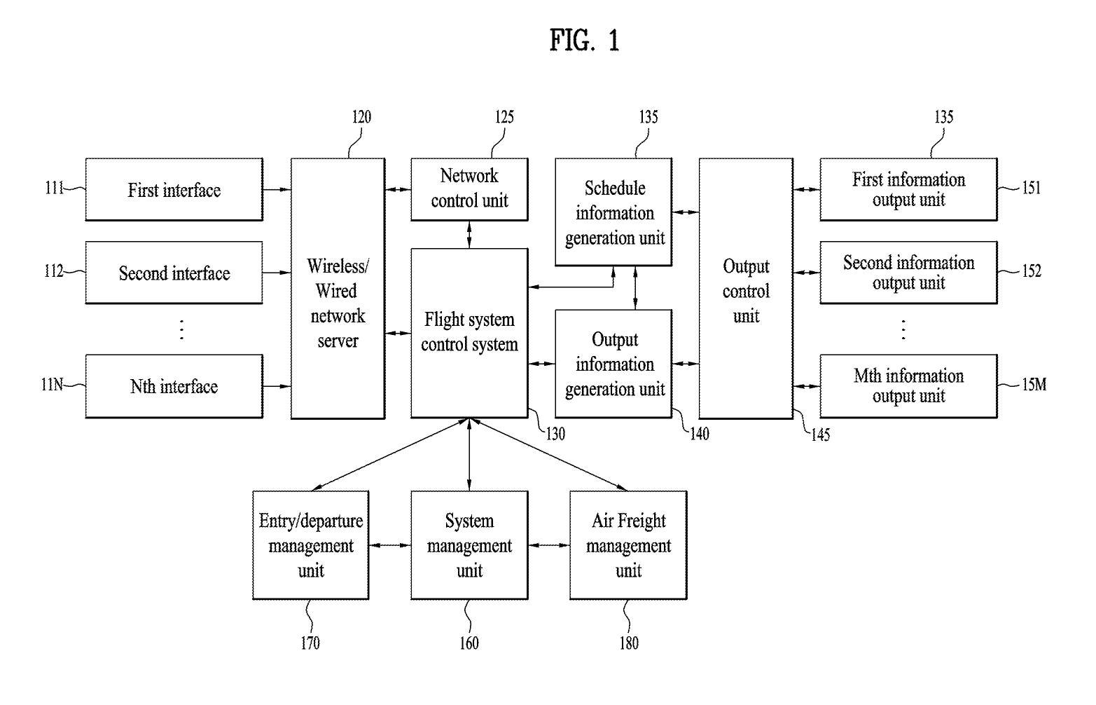

FIG. 1 is a block diagram illustrating a structure of a digital system, i.e., a system for providing flight information.

An example of a system for providing flight information, which is disclosed in this disclosure, includes a control unit identifying an airport user, controlling to generate and provide flight information to the identified airport user, receiving a predetermined item or an information request signal within the provided flight information, and controlling a processing corresponding to the received item or information request signal, and an information providing device outputting the flight information and processed results corresponding to the request signal, wherein the control unit controls to provide flight information including visual information respective to entry and departure and airplane flight information linked to the visual information in at least one format of a map, a graph, and a three-dimensional (3D) display, and wherein the information providing device includes at least one of a mobile device of the identified airport user and a previously installed in-airport display device.

Meanwhile, as described above, the control unit may perform control to generate the flight information further including at least one of entry and departure information, air freight information, advertisement information, and route information, the control unit may control a selected item to be automatically aligned based on at least one of point of departure, point of arrival, time information, airline information, and continent information, and the selected items to be marked differently from other items by at least one of color and size or to be highlighted, and the control unit may identify a user by sensing at least one of an identification including a passport, a plane ticket, and a mobile device through at least one of a barcode reader, a Quick Response (QR) code reader, and a proximity sensor.

Additionally, as described above, in case, if the information providing device corresponds to a mobile device of the identified airport user, and a flight information application is not installed in the mobile device, the control unit may control the flight information application to be downloaded, and, if the information providing device corresponds to the previously installed in-airport display device, the control unit may receive and processes the request signal through a touch input, and the control unit may controls multiple sets of flight information to be simultaneously outputted, each of multiple sets of flight information being configured to have a different format, to a display screen of the information providing device.

Furthermore, if any one of the multiple sets of flight information is accessed, the control unit may control other flight information being related to a request made by the accessed flight information to be outputted by being sequentially modified or aligned.

Referring to FIG. 1, the system for providing flight information may be broadly divided into a flight information providing unit, a flight information outputting unit, and a flight information interface unit.

The flight information providing unit includes a airport system control unit (130), an output information generation unit (140), and so on, as configuration elements related to all data processing related to the airport system. Herein, the flight information providing unit may further include at least one of a wired/wireless network server (120), a network control unit (125), a schedule information generation unit (135), an output control unit (145), and so on.

Meanwhile, the airport system control unit (130) corresponds to a configuration element, which performs a function of controlling the entire airport system, and, accordingly, the airport system control unit (130) communicates with a system management unit (160), an entry/departure management unit (170), an air freight management unit (180), and so on, so as to send and receive data to and from one another or to control each component.

The system management unit (160) performs a function that is similar to that of the airport system control unit (130), and, herein, for example, the system management unit (160) may perform monitoring, managing, and controlling of the airport system control unit (130).

The entry/departure management unit (170) manages events, such as schedules, of all flights taking off from and landing to the airport.

The air freight management unit (180) communicates with the entry/departure management unit (170), the airport system control unit (130), and so on, and, most particularly, refers to the schedule of flights (or airplanes) flying in and out of the airport in order to manage whether or not air freight has been adequately and properly loaded to its respective flight or whether or not the air freight has been properly delivered to the user from its respective flight.

The wired/wireless network server (120) supports and provides all wired/wireless network environments that are required between the flight information interface unit, which will be described later on, the flight information providing unit, and the flight information outputting unit, and the wired/wireless network server (120) may also support a network environment for performing communication with an external device. Such wired/wireless network server (120) may, for example, receive control from the network control unit (125) or the airport system control unit (130).

The schedule information generation unit (135) generates schedule information, which is configured in a format that can be outputted through the flight information output unit, based upon the schedule events of all departing/landing flights, which is managed by the entry/departure management unit (170).

Meanwhile, the output information generation unit (140) generates output information that is required for providing the schedule information generated by the schedule information generation unit (135) as well as all types of other information requested by the flight information outputting unit.

The output control unit (145) performs control operations allowing information that is received from the schedule information generation unit (135), the output information generation unit (140), and so on, to be outputted through the flight information outputting unit. Herein, the output control unit (145) may mix multiple sets of information by including a mixer, a formatter, and so on, or the output control unit (145) may provide information in a 3D (3-Dimensional) format through a formatter, and so on.

The flight information interface unit refers to an interface device, which is configured to include at least one or more interface units (111 to 11N, wherein N corresponds to a positive integer), and which is required for requesting for or selecting content from the flight information providing unit and/or the flight information outputting unit.

Additionally, the flight information outputting unit also includes at least one or more output unit (151 to 15M, wherein M corresponds to a positive integer), so as to output diverse information being requested through the flight information interface unit or being transmitted from the flight information providing unit. Meanwhile, although the flight information interface unit and the flight information providing unit are illustrated and described as separate elements, the flight information interface unit and the flight information providing unit may be modulated and configured as a single element.

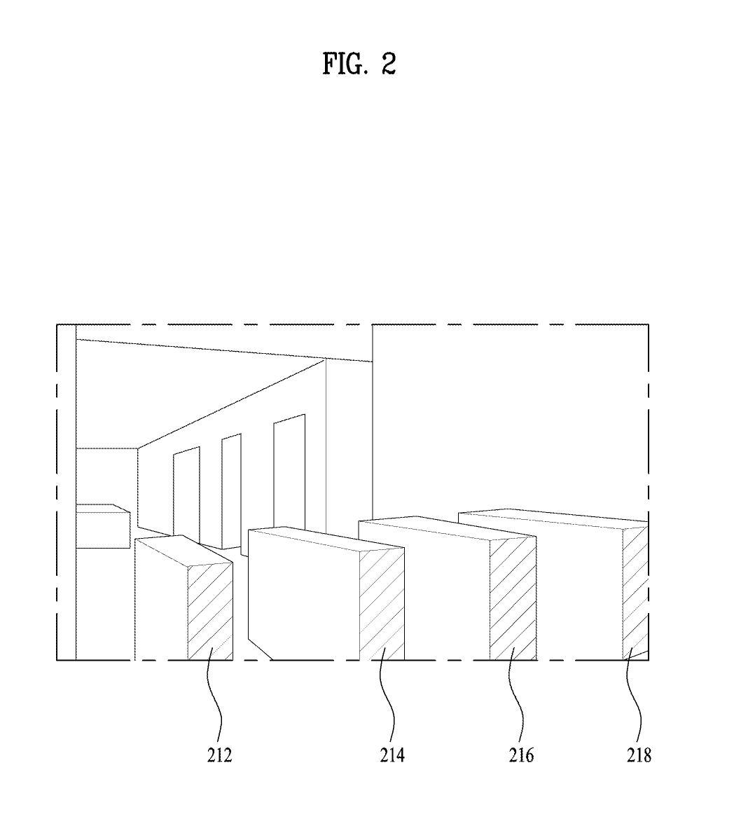

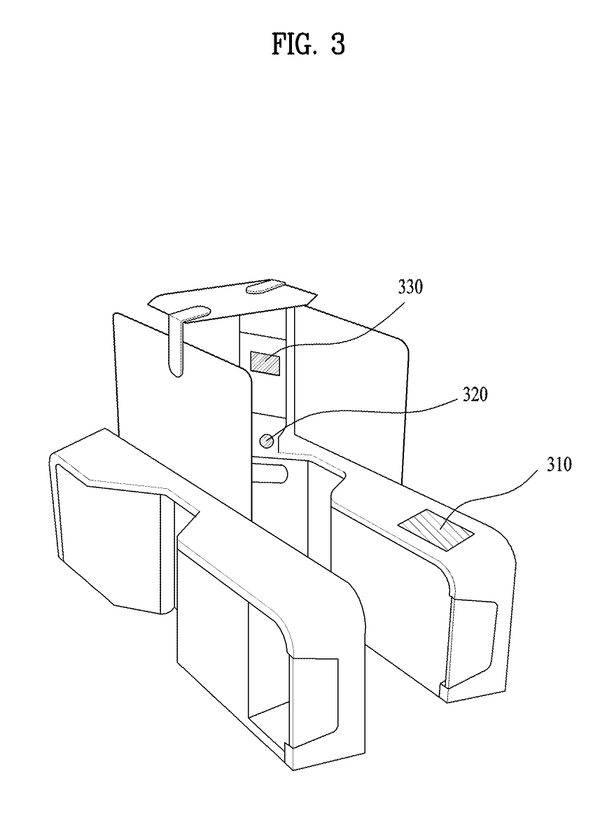

FIGS. 2 and 3 are exemplary embodiments illustrating configurations of user entry and exit gates in an airport. For example, FIG. 2 may illustrate an airport entrance or an entry and exit gate that is used when departing the country, and FIG. 3 may illustrate an entry and exit gate that is used when entering the country.

Referring to FIG. 2, 4 entry and exit gates are illustrated. This is merely exemplary, and, as described above, in case of entry and exit gates that are only installed at the airport entrance, the entry and exit gates may be used only for the purpose of passing through. However, in case of entry and exit gates that are used at the point of entry and departure, the entry and exit gates may also be used for checking plane tickets for departing the country or passports and also for deciding whether or not to authorize entry to the country.

Meanwhile, even if the entry and exit gates are installed at the airport entrance, as described later on, by checking passports or other identification, plane ticket reservation receipts, and so on, registration procedures that are required for later usage of the airport facilities may be automatically processed.

When an airport user passes through the entry and exit gate, the user may user a display device or digital device for registering a user or mobile device located nearby, or for receiving a mobile device that has been prepared in advance by the airport.

Alternatively, even if a separate device is not used, as described above, information on the user having passed through the entry and exit gate or information on the mobile device of the corresponding user may be automatically searched from a transmitter, which is installed within close range of the exist and entry gate, and, then, an application for suing the airport may be recommended to the searched mobile device, and then the recommended application may be advised to be downloaded. As described above, after downloading the application for using the airport through the mobile device, the user of the mobile device may carry out the above-described procedures, such as registration, without experiencing any limitations in time and space, and, whenever required, by carrying out ticketing procedures for a scheduled flight, the user may use the corresponding mobile device without having to wait in a separate waiting line.

Meanwhile, the above-described registration procedure may be realized not only through download but also through a reader for reading barcodes or QR codes (Quick Response codes), proximity sensors or NFC (Near Field Communication) (hereinafter referred to as proximity sensors), or through tags, and so on, and, in case it is difficult to process wireless download, download may also be performed through display devices provided in several locations within the airport.

The convenience in using the airport respective to such registration process will be described in detail later on when describing the corresponding part, and, therefore, the detailed description will be omitted herein.

Referring to FIG. 3, the entry and exit gate corresponds to a configuration that can verify information on the user when enter or departing from the country and that can verify entry/departure or decide whether or not to authorize entry/departure.

The entry and exit gate is configured to include a reader (310), a sensor (320), and an information verification screen (330).

The reader (310) corresponds to a configuration that is used for verifying light information of the user and for receiving and verifying information for identifying the user. The flight information or identification information may, for example, be used through the user's flight ticket or passport, and, for this, the reader (310) may correspond to a barcode or QR code reader.

The sensor (320) performs the function of another reader, and, herein, for example, the sensor (320) may correspond to a fingerprint recognition device or a proximity sensor. The sensor (320) may search and sense flight information or identification information of the user and may then communicate the sensed value to a server.

For example, the sensor (320) is equipped with a proximity sensor or a Tag, so as to be capable of searching for a digital device, such as the mobile device of the user, and, in case the searched digital device corresponds to a device that has been registered in advance, diverse information that can be used in the airport may be transmitted to the corresponding device. Whenever required, the sensor (320) may also download an application to the corresponding device. More specifically, the sensor may transmit a sensing value to the server, and, then, based upon a sensing value transmitted from the server, the sensor may transmit the received information back to the mobile device of the user.

The information verification screen (330) outputs the information that is verified through the reader (310) and/or the sensor (320), additional information respective to the verified information, information processing situation or status, and so on.

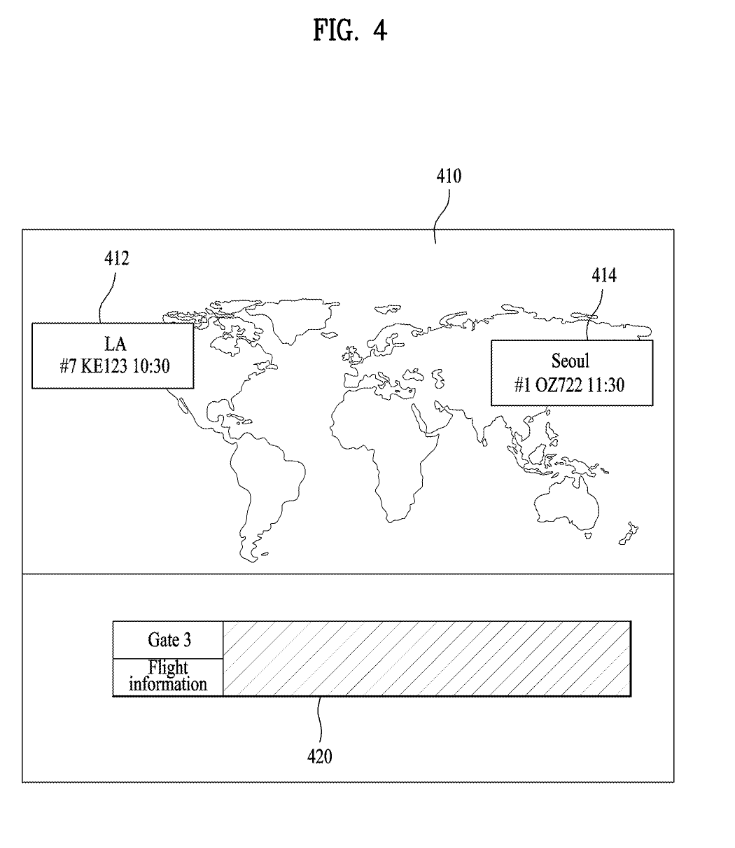

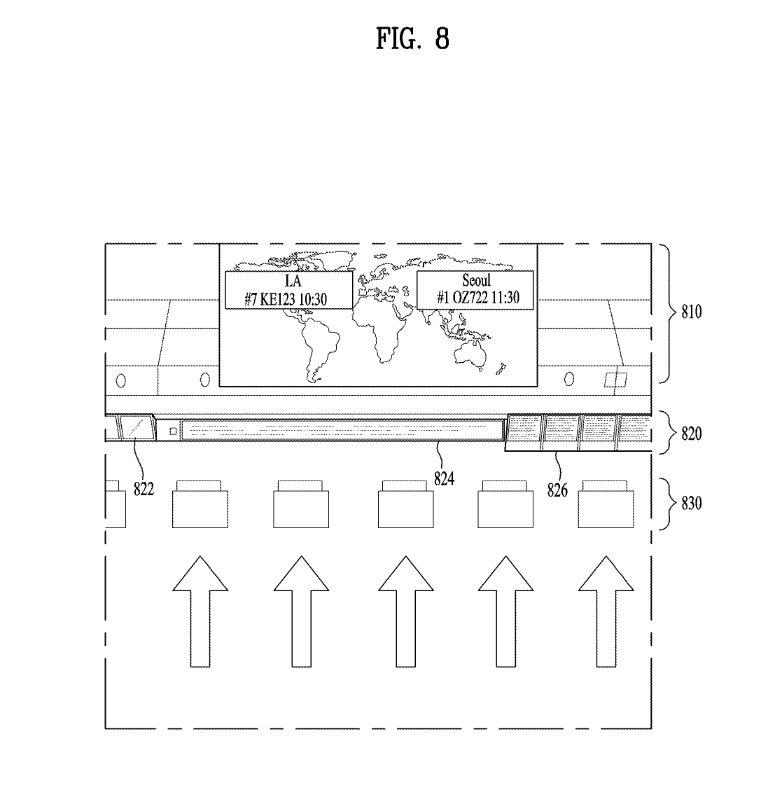

FIGS. 4 to 7 and/or FIGS. 8 to 21, which will hereinafter be described in detail, disclose, for example, exemplary embodiments of diverse methods for configuring flight information that can allow airport users to recognize flight information within the airport more conveniently and intuitively and diverse display devices that can perform interfacing of such flight information.

FIGS. 4 to 7 illustrate exemplary embodiments of flight information configuration.

Meanwhile, FIGS. 4 to 7 may be provided to all users undergoing the entry/departure procedure.

Referring to FIG. 4, the flight information includes a first part (410) outputting map information and a second part (420) outputting flight information. Herein, the map information of the first part (410) and the flight information of the second part (420) are provided by being linked to each other.

The first part (410) corresponds to information that is realized in the form of a map, such as a world map, and such map may be provided to the user in a 2D (2-Dimensional) or 3D format.

Information on each city from which or to which the flight is entering/departing through the airport may be marked on the map at the respective locations. For example, if the current airport is the Incheon Airport, all cities to which the airplanes that have departed from Incheon Airport are expected to arrive may be marked. Herein, even though Incheon Airport does not correspond to a point of departure or a point of arrival, if Incheon Airport is a stopping point, all related cities may be marked. Meanwhile, as described above, in order to facilitate the identification of each user, the point of departure, the point of arrival, the stopping point, and so on, may be marked in different colors, or, in accordance with the user's selection, the corresponding city (cities) may be distinguished by highlighting or blinking effects and then provided to the user. Additionally, each city may also collectively display an adequate identifier.

Additionally, with a predetermined area of the map, information or indicators (412, 414) on flights that will be departing or arriving after the current time or after a predetermined time may also be provided.

Referring to FIG. 4, a first indicator (412) is being outputted on an upper left portion, and a second indicator (414) is being outputted on an upper right portion, and, herein, the first indicator (412) is marked as “LA #7 KE123 10:30”, which may indicate that flight number KE123 departing from LA has arrived at Gate No. 7 at 10:30 or that flight number KE123 departing to LA will be departing from Gate No. 7 at 10:30. Similarly, as described above, the second indicator (414), which is marked as “Seoul #1 OZ722 11:30”, may indicate that flight number OZ722 departing from Seoul has arrived at Gate No. 1 at 11:30 or that flight number OZ722 departing to Seoul will be departing from Gate No. 1 at 11:30.

Meanwhile, such indicators may be provided at locations, which are mapped to the corresponding city or destination within the map based upon the point of departure or point of arrival, and the indicators may also be provided in series within a predetermined area of the map based upon diverse reference points, such as time, order or airline, continent, and so on. In case of the latter, when any one indicator is selected in accordance with the user's selection, a marking within the map that is linked to the selected indicator is provided in diverse forms, such as color, highlight, a moving plane icon, and so on. Alternatively, the above-described indicators may be outputted to the map simultaneously, or the indicators may be marked in a predetermined area of the map, and, then, when selected by the user, the corresponding indicator may be enlarged, so as to provide the corresponding information more easily.

The second part (420) provide flight information, and, as described above, the flight information that is being provided as described above may be provided by being linked to the indicator or information within the map that is selected in the first part (410), and the flight information that is being provided accordingly may include diverse information. Generally, the flight information may provide at least or more of time information, airplane identification information, point of departure/point of arrival information, airline information, passenger information, air freight reception information, gate information, and so on.

Meanwhile, the positions of the first part (410) and the second part (420) shown in FIG. 4 may be provided by having their positions switched to an up-and-down (or vertical) layout or to a left-and-right (horizontal) layout.

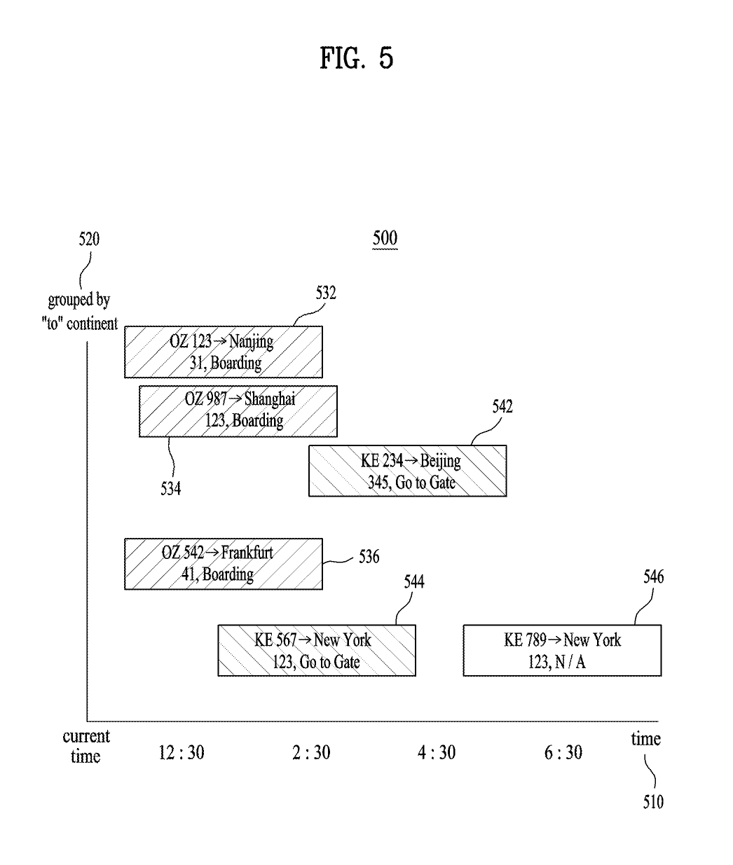

The flight information (500) of FIG. 5 may be provided by replacing the information of the first part (410) or the second part (420) of FIG. 4, or by being combined with or along with at least one of the parts, and, herein, a horizontal axis (510) includes visual information, and a vertical axis (520) included flight information that is related to the visual information of the horizontal axis.

The visual information of the horizontal axis (510) provides a time of a predetermined range respective to the past and/or the future based upon the current time. This may be provided as default settings, and, in accordance with the user's selection, the visual information of the horizontal axis may perform horizontal movements, so that the corresponding time information can be outputted.

The flight information of the vertical axis (520) is provided by being linked to the visual information of the horizontal axis (510). However, flight information that is grouped to a predetermined unit shall be provided. Herein, the predetermined unit includes at least one of point of arrival, point of departure, stopping point, airline, continent, and so on.

Referring to FIG. 5, the vertical axis (520) is grouped by “to” continent based upon the time of the horizontal axis (510), and first to third items (532 to 536) may be configured as one group, and another group may be formed at another time, and in order to be distinguished (or differentiated) from other groups, each group may be colored or highlighted. If the configuration of the group is varied in accordance with the user's selection, or, in case the time is varied, information on another group may be provided accordingly.

Herein, each item may include flight information, such as airline/airplane information, destination (or point of arrival), gate information, current status information, and so on. And, herein, for example, the status information may correspond to Boarding, Go to gate, N/A (Not Available), and so on.

Meanwhile, in FIG. 5, flight information respective to departure, entry, or entry/departure may be displayed simultaneously.

For example, in case the description provided above corresponds to a description on a departure, the entry may also be configured by using a similar method, except that the timeline shall be configured by an inverse order.

Additionally, in case the entry/departure are marked at the same time, for example, based upon a predetermined time corresponding to the center portion of the time axis, entry may be provided in a group unit of the vertical axis on the left side, and output may be provided in a group unit of the vertical axis on the right side. Alternatively, as described above, the time axis may be remained unchanged, and the respective information may be provided in a vertical configuration instead of the horizontal configuration and may then be provided simultaneously. In this case, a predetermined reference time may be marked vertically as a solid line, so as to provide the user with convenience identifying the information.

Or, the information may be configured as shown in FIG. 5. However, by providing the departure item and entry item by marking them in different shapes, sizes, colors, or highlights, the user may be capable of immediately recognizing the corresponding information intuitively.

Although it is not shown in the drawing, information that is similar to the second part (420) of FIG. 4 may be provided on a lower end of the horizontal axis shown in FIG. 5 or on its opposite end (upper end). In this case also, other information may be provided by linked to this information based upon the time, and item, which is selected in FIG. 5.

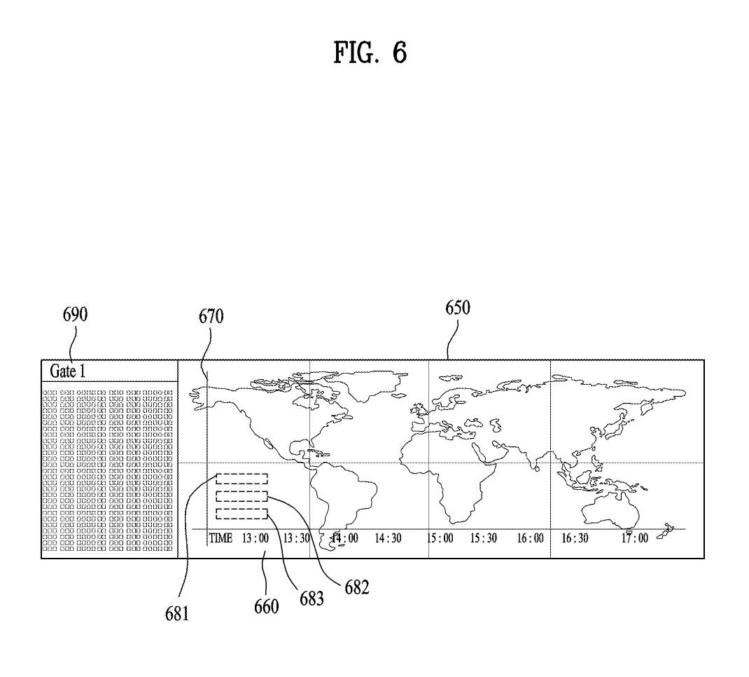

For example, FIG. 6 may be viewed as a method for configuring the flight information that consists of a combination of FIGS. 4 and 5. For example, the basic configuration may be configured as a left-and-right format instead of an up-and-down format, just as the flight information configuration method of FIGS. 4 to 5. However, a third part (610) of FIG. 6 performs a similar function as the second part (420) of FIG. 4, and a fourth part (650) of FIG. 6 is similar to the first part (410) of FIG. 4 and/or the flight information configuration of FIG. 5. However, the information included in the parts of FIG. 6 may be different from that of FIGS. 4 to 5.

The fourth part (650) may correspond to a combination of the first part (410) of FIG. 4 and FIG. 5. More specifically, the fourth part (650) may have the form of a map, such as a world map, in order to provide convenience in intuitively recognizing the wanted information of the user. However, in the map format, as shown in FIG. 5, a horizontal axis (660) is additionally configured as a time axis, and a vertical axis is additionally configured as a group axis.

Herein, flight information may also be provided within the map information, and, based upon the time axis (660), the corresponding information may be hierarchically layered and provided to the user, so that the user can intuitively recognize the corresponding information.

The flight information that is provided within the map information may be configured to each be distinguished from one another based upon a reference point that is selected by the user, or based upon a default reference point, and the information may then be provided accordingly. For example, by providing the flight information provided in the third part (610) and the flight information provided in the fourth part (650) in the same color, the user may be capable of intuitively recognizing the correlation between the information provided in each part more conveniently.

Meanwhile, the map information may be configured to be aligned to adequate positions within the map based upon diverse reference points, such as departure/arrival, now boarding, discharging/receiving air freight, by continent, by time unit, and so on.

Such third and fourth parts (610, 650) may be controlled by a touch of the user or by the mobile device.

Although the third part (620) is illustrated as an example of configuring the flight information in gate units in FIG. 6, the flight information may be diversely configured based upon diverse reference points, such as airline units, and so on. Meanwhile, the third part (610) may also be configured to be identical or similar to the second part (420) of FIG. 4.

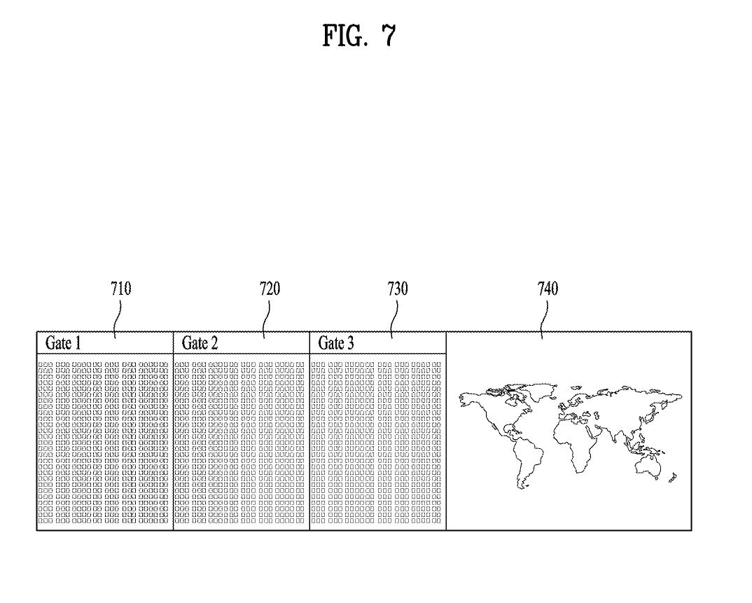

Although FIG. 7 has a similar configuration as FIG. 6, which is described above, a fifth part (710 to 730) of FIG. 7 that corresponds to the third part of FIG. 6 consists of multiple parts. However, referring to FIG. 7, a sixth part (740) of FIG. 7 is very similar to the first part (410) of FIG. 4. However, the sixth part (740) may be configured to be identical to the fourth part of FIGS. 5 to 6 or may be configured to be completely different from the fourth part.

Herein, the fifth part (710 to 730) may respectively output information items related to departure, entry, and air freight. However, the information on each item may be aligned differently, or may correspond to items that are completely different from the above-described items, i.e., information items, such as entry, departure, flight, continent, time line, terminal or gate, and so on.

The same information as the above-described FIGS. 4 to 6 may be provided in the sixth part (740), or general airport information may be provided to the sixth part (740). For example, such general airport information may include diverse information, such as shopping information, advertisement information, airport map information, and, also, other news or weather information, urgent information, and so on. In other words, as information related to the fifth part (710 to 730), the sixth part (740) may provide more detailed information or additional information, or the sixth part (740) may provide completely unrelated information that has no link to the information of the fifth part.

Meanwhile, in FIGS. 4 to 7, time information is provided, and, when a timeline that is wanted by the user is selected, the flight information is updated based upon the selected timeline, which may then be provided to each part. Meanwhile, in each case, when there is no input from the user for a predetermined period of time, the outputted information is shifted back to the information corresponding to default settings. Alternatively, in case the flight information is configured to output specific information, by blocking the input or selection of the user, the information may also be configured to be recognized by all users. For example, in case of information that should be urgently and collectively delivered to all users within the airport, such as delay or cancellation of flight departure or arrival due to terrorist attack within the airport or weather conditions, in order to be provided to all user, authority for changing or deleting such information may not be assigned to specific users.

Hereinafter, among the above-described FIGS. 4 to 7, when flight information is configured of any one of the above or a combination of two or more of the above, diverse exemplary embodiments corresponding to the structure of display devices outputting such flight information, or diverse exemplary embodiments corresponding to usage scenarios directing how such information is being applied and used in an actual airport through such display device will be described in detail.

FIGS. 8 to 21 illustrate diverse exemplary embodiments of flight information usage scenarios.

For example, FIG. 8 illustrates a display device that is provided at a location where a user tickets his (or her) plane ticket for departure, and it is also shown herein how the flight information is configured in the display device.

FIG. 8 is broadly configured of 3 parts in accordance with the position at which the display device is provided.

A first part (810) corresponds to a large display device, which, for example, provides flight information of the first part of FIG. 4 and the second part of FIGS. 5 to 6 and 7. Meanwhile, the first part (810) may be configured based upon the flight information of the respective airline in accordance with the characteristics of the location for ticketing a plane ticket. Additionally, as described above, the first part (810) may be divided into multiple screen, thereby providing information of each divided sections that are linked to one another, or separately providing information that are irrelevant to one another, or, as it will be described later on, the first part (810) may be provided by being linked to the information of the second to third parts (820 to 830). For example, in the divided first section, ticketing information may be outputted, and in the divided second section, flight information may be outputted, and completely different flight information may be outputted to the section, or the section may be further divided so as to be capable of outputting the corresponding flight information.

The second part (820), for example, provides brief pre-ticketing information along with order (waiting) information, and such information are provided in relatively smaller-sized display devices as compared to the first part (810). However, as shown in FIG. 8, the small sized display device may be configured in diverse forms (822, 824, 826) and then provided, and each display device (822 to 826) may output different information.

Additionally, for example, although it is not clearly shown in the drawing, the third part (830) illustrates display device that is equipped within each terminal that helps the ticketing process.

Herein, by providing the same information in accordance with the size of the display device, the first part (810) to the third part (830) may provide convenience in the user's identification as well as convenience in the processing status, and so on. Alternatively, completely different information or correlated yet not identical information may be provided in accordance with the characteristics of each display device.

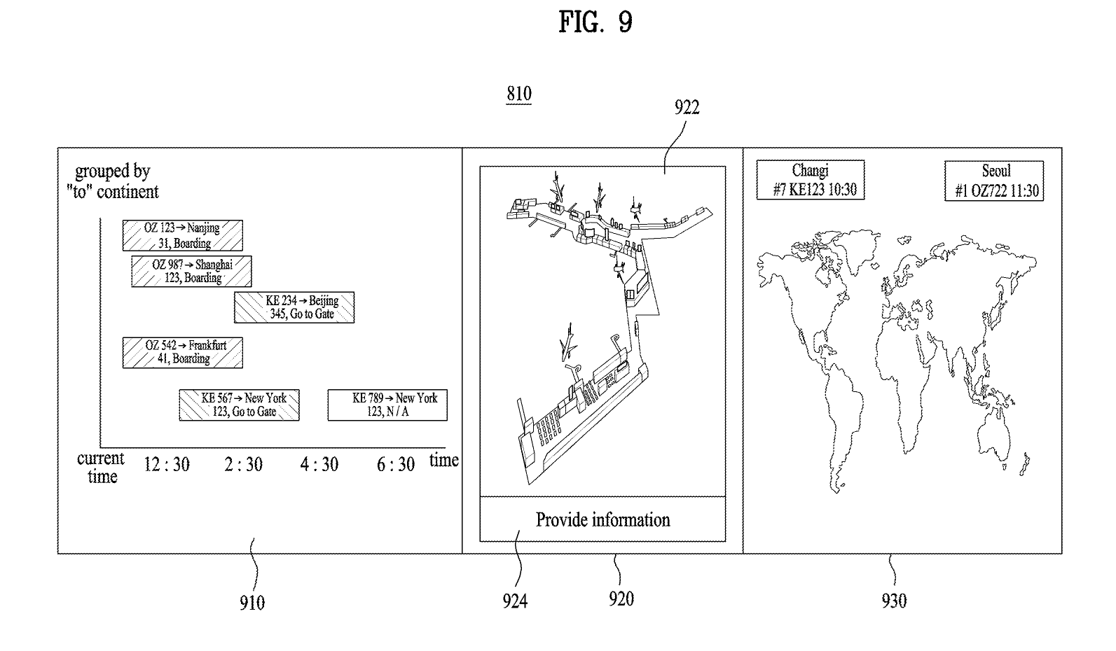

For example, although FIG. 9 illustrates a newly configured first part (810) of FIG. 8, this may correspond to another part of FIG. 8 or flight information being provided on another display device, which will be described later on.

Referring to FIG. 9, for simplicity in the description, the flight information will be described by sequentially referring to first section (910) to third section (930) starting from the left side.

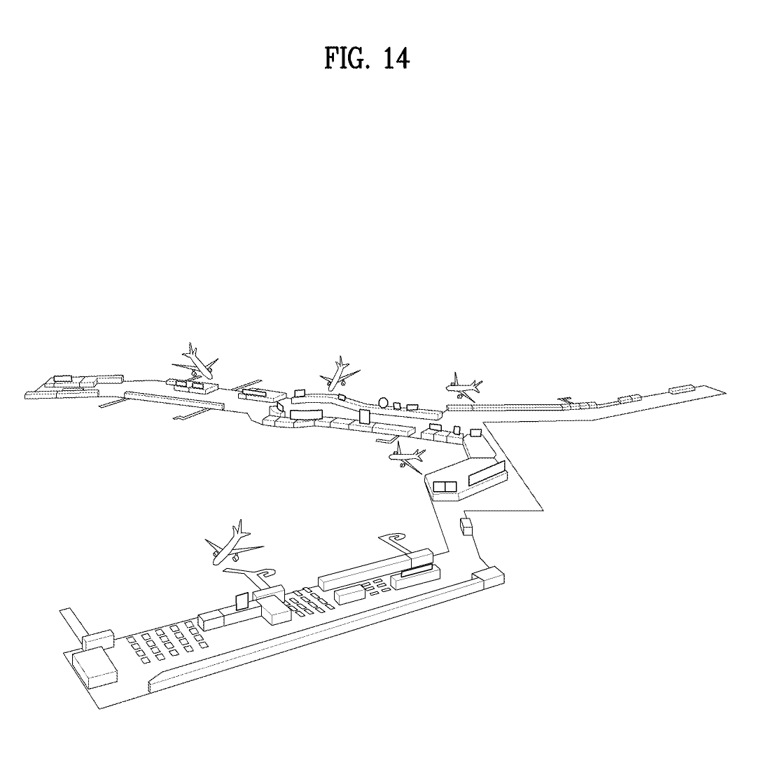

A first section (910), for example, is configured of the above-described flight information of FIG. 5, a second section (920) is configured of the flight information of FIG. 14, which will be described later on, and a third section (930) is configured of the flight information combination of the first part (410) of FIG. 4. Herein, the second section (920) may also be configured to include the flight information of FIG. 14 in its upper portion (922) along with an information providing section in its lower portion (924). Meanwhile, the description of the second section (920) will be described in more detail later on when describing the corresponding part later on, and, therefore, detailed description of the same will be omitted herein.

Meanwhile, each set of information of the first section (910) to the third section (930) of FIG. 9 may have the position of one another switched, and, when any one section is selected by the user, another section may be changed to a detailed information window of the corresponding section. At this point, the detailed information window may provide more detailed and more distinguished information of the selected section as compared to its initial information configuration, or the information may be completely and newly reconfigured and then provided.

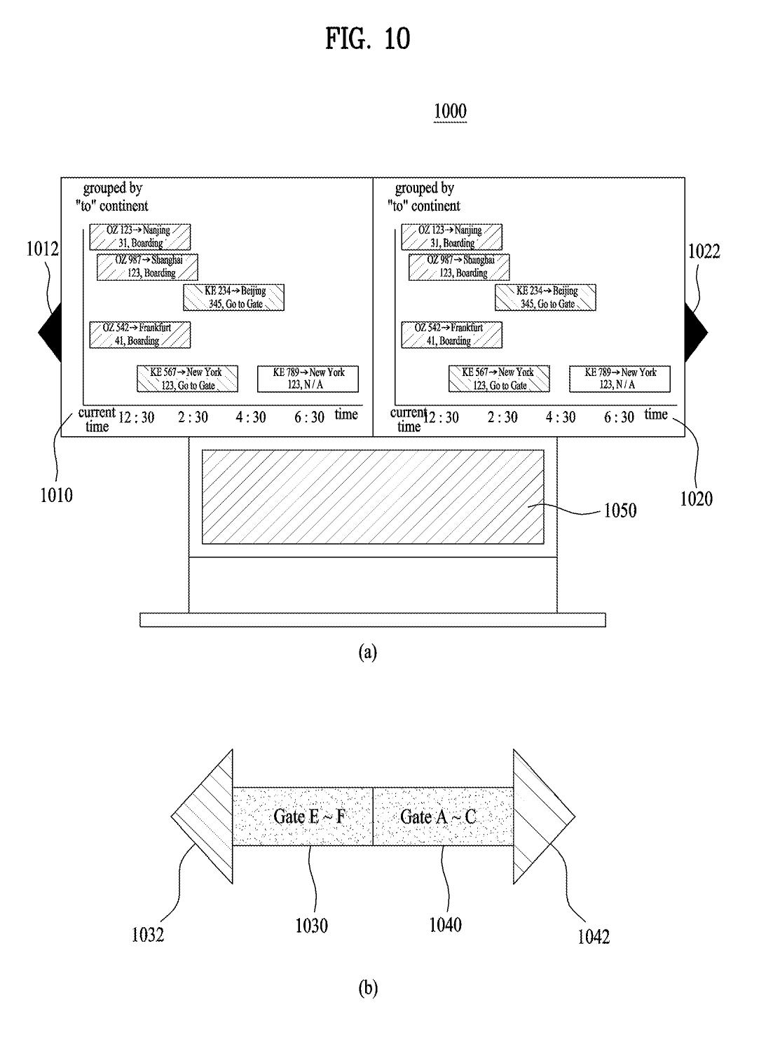

FIG. 10(a) illustrates an example for describing a display device (1000) providing two different types of flight information, and, herein, for example, as shown in FIG. 9, such display device may be positioned at any general location within the airport other than the ticketing location.

Referring to FIG. 10(a), the display device (1000) includes two parts (1010, 1020) as its main part in which flight information is outputted, and the display device (1000) further includes one part (1050) as its supplemental part in which additional information is outputted. Meanwhile, just as the main part, flight information may also be outputted in the supplemental part.

Each section of the main part may be configured of one display having its screen divided into at least two sections, or may correspond to two displays being physically joined.

Meanwhile, the first section (1010) and the second section (1020) may output the same or different flight information.

In FIG. 10(a), for example, the flight information of FIG. 5 is being outputted to each section. Herein, however, as shown in FIG. 10(b), the drawing of each section may, for example, be provided so that the corresponding items related to the identification information of the gates, which are installed in front of the display device of FIG. 10(a), can be marked and displayed to be distinguished from other items. For example, in FIG. 10(b), Gates E to F (1030) and an identifier, i.e., arrow (1032) identifying a direction toward the corresponding gates are illustrated on the left side, and, conversely, Gates A to C (1040) and an arrow (1042) are illustrated on the right side, and, herein, as shown in FIG. 10(b), in each section of the display device of FIG. 10(a), the first section (1010) provides flight information corresponding to Gates E to F that is distinguished from other flight information and also displays an arrow (1012) in the display device, which corresponds to the arrow (1032) of FIG. 10(b). Meanwhile, the second section (1020) also provides flight information corresponding to Gates A to C that is distinguished from other flight information and also displays an arrow (1022) in the display device, which corresponds to the arrow (1042) of FIG. 10(b). Accordingly, although the first section (1010) and the second section (1020) have the same format, the flight information being provided therein may be different from one another.

Although the section (1050) of the supplemental part corresponds to a section generally providing advertisement information, as described above, whenever required, flight information or other additional information may be provided herein.

Meanwhile, unlike what is shown in the drawing, at least one of the first section (1010) and the second section (1020) of the display device of FIG. 10(a) may be replaced with the information of at least one of FIG. 4, and FIGS. 6 to 7.

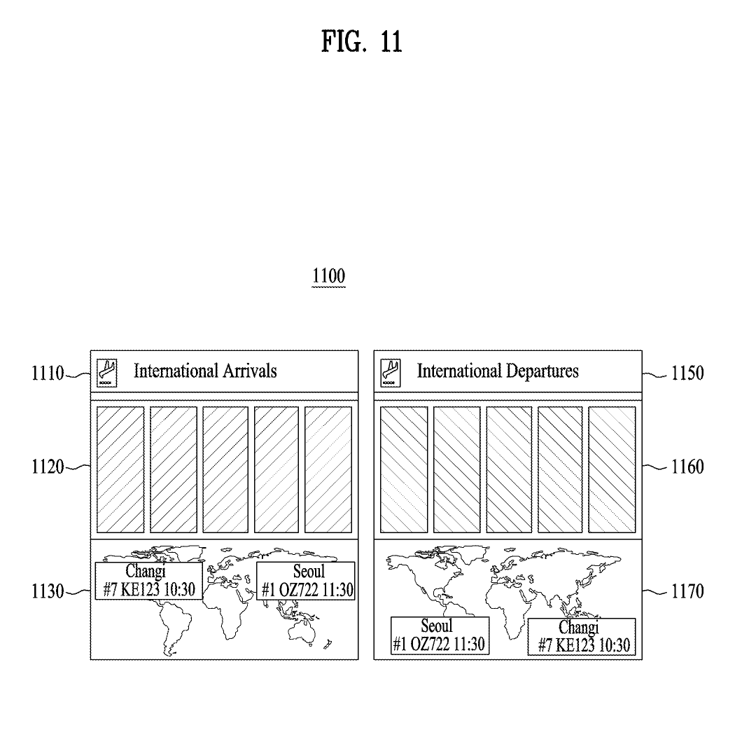

FIG. 11 may correspond to another flight information configuration, which is different from that of FIGS. 4 to 7, or may correspond to an information providing screen within the display device. For simplicity in the description, description will be made on a display device (1100). Meanwhile, FIG. 11 corresponds to two display devices being aligned side-by-side, and, for simplicity in the description, the description will be made mostly on one of the display devices, and for the remaining device, reference will be made to the description of the display device, and only the differences will be described in detail.

The display device of FIG. 11 is broadly divided into three sections, and each section may have a different information type or characteristic being provided thereto, and the information of any one section may be related to the information of another section.

A first section (1110) indicates an identifier indicating that information on International Arrivals and not Domestic Arrivals is being provided.

A second section (1120) and a third section (1130) correspond to sections in which the flight information is being outputted, and, herein, for example, detailed information of the third section (1130) may be outputted in the second section (1120). Meanwhile, the positioning of the second section (1120) and the third section (1130) may be opposite to one another. Additionally, the second section (1120) and the third section (1130) may each be touchable (or recognized by touch).

In FIG. 11, although the map information of FIG. 4 is illustrated in the third section (1130), the present invention will not be limited only to this, and therefore, the map information may be replaced with any one type of flight information of FIGS. 5 to 7. This may also be equally applied to the second section (1120).

Meanwhile, the description on the first section to the third section (1110 to 1130) of the left side display device may be equally applied to a first section to a third section (1150 to 1170) of the right side display device without any modification. However, in case the left side display device provides information on International Arrivals, the right side display device may provide information on International Departures. By using the same method, each section information of the right side display device may not be identical to the respective information of each section of the above-described left side display device. B For example, the positioning of the information may be different, or different type of information may be provided.

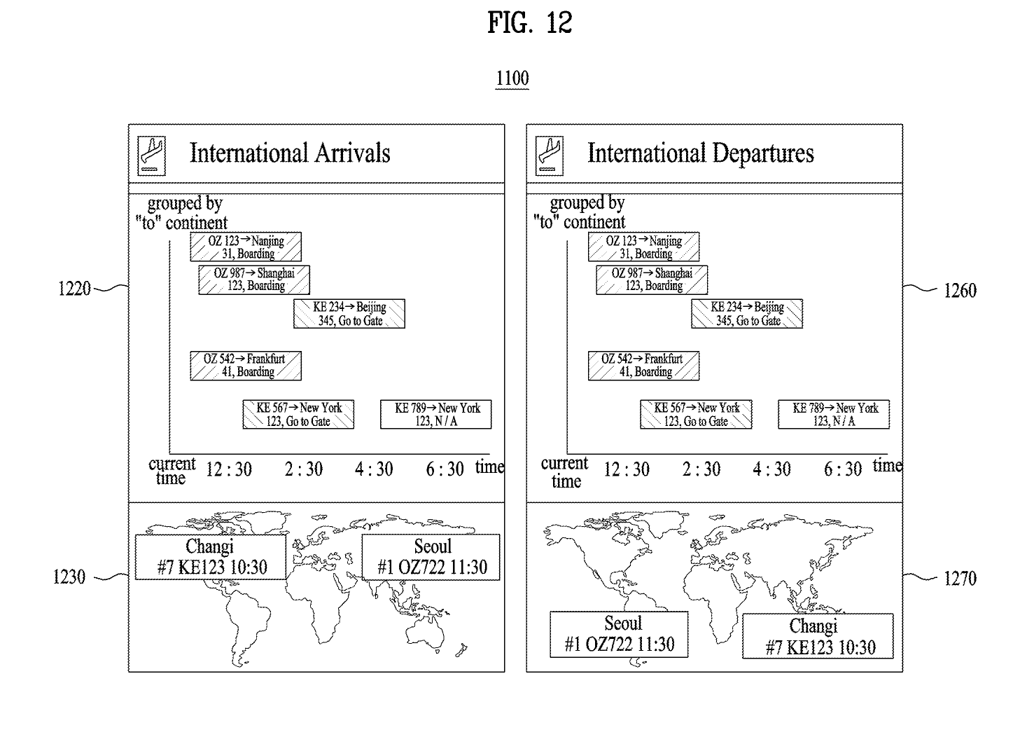

As described above, FIG. 12 illustrates another configuration of FIG. 11. For example, FIG. 12 corresponds to an exemplary embodiment, wherein, unlike FIG. 11, the second section (1220, 1260) information is replaced with the flight information of FIG. 5.

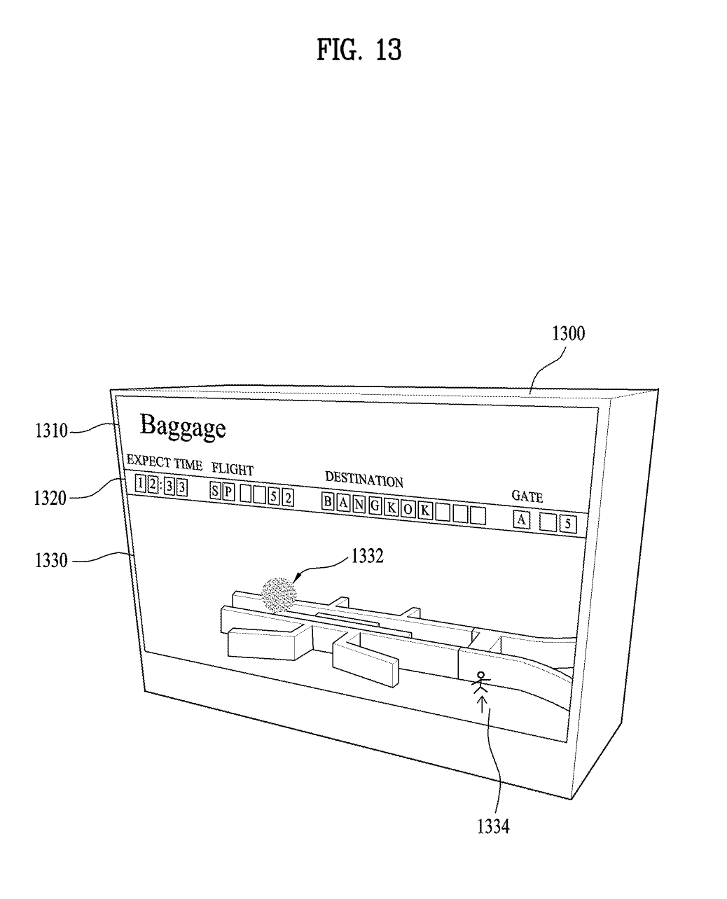

Referring to FIG. 13, information title may be displayed on an upper portion, so that the information can be recognized as departure or arrival information, and information may be provided by including flight information (1310) and route or path information (1320).

Herein, the flight information (1310) includes time information, flight information, destination, and gate information. Herein, for example, the time information may indicate a time remaining before the departure or arrival of the flight, which is being outputted as the flight information, from the current time. Additionally, the gate information may correspond to information on the boarding gate or the arrival gate.

Meanwhile, the route or path information (1320) of FIG. 13 may display the current position information (1310) and a position (1320) of the boarding or arrival gate, and, whenever required, route or path information starting from the current position up to the gate may also be provided.

Such information of FIG. 13 may, for example, be entirely provided in the 3D format or any one type of information may be provided in the 3D format, thereby providing convenience to the user in recognizing the information.

In FIG. 13, the user may be capable of selecting the flight information (1310) by touch or through a mobile device. Additionally, the user may also request for the route or path information (1320) to be shifted to map information along a horizontal and/or vertical direction, and the corresponding display device may provide the map information, which is shifted in accordance with the corresponding request.

For example, FIG. 14 corresponds to an exemplary embodiment of another configuration of the flight information, which illustrates 3D map information on airplanes and gates.

Meanwhile, such 3D map information of FIG. 14 may be moved along up-and-down-and-left-and-right directions in accordance with the user's selection.

Additionally, each gate or terminal of FIG. 14 provides identification information, and the airplanes may be marked in different colors in accordance with their departure or arrival, and, if there is no plane, the corresponding gate or terminal may be marked as not available.

Additionally, the size of the plane being outputted to the flight information of FIG. 14 may also vary in accordance with the size of the actual plane.

Meanwhile, when the user accesses a predetermined section or item of FIG. 14, detailed information may be provided in the surroundings of the corresponding section or item.

Meanwhile, the above-described information including the flight information may be identified by changing/selecting the corresponding information by having the user download the corresponding information through the mobile device or by transmitting the wanted data instead of having the user directly touch the corresponding information.

Meanwhile, in case multiple sets of flight information are being outputted, the flight information may be provided by distinguishing the information corresponding to the selected items and non-selected items by using different colors or by using activation/inactivation methods.

Additionally, the map information may modify its screen configuration in accordance with the user's selection. For example, when the user requests for route or path information respective to a gate, which is recognized for boarding or arrival, a route or path from the current position to the corresponding gate or the shortest route (or path) information is provided. In this case, the route or path information may be downloaded to the user's mobile device, which was registered through FIG. 2 and/or FIG. 3.

Moreover, all information including the 2D/3D format flight information, which is described in this disclosure may, for example, may not only have a predetermined section of the corresponding information selected by the mobile device or by a motion or touch, but may also have processed diversely, such as having a predetermined section of the corresponding information enlarged or reduced.

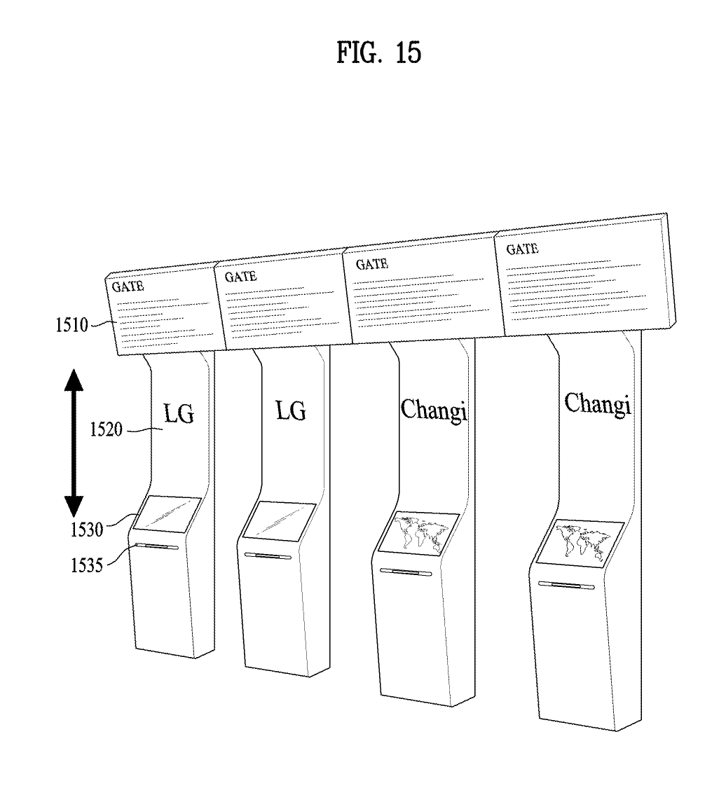

FIGS. 15 to 20 illustrate exemplary embodiments of the display device configuration for verifying flight information.

FIGS. 15 to 20 correspond to display devices positioned at diverse locations within the airport, and these are used for the user's convenience in using the airport.

The display device of FIG. 15 is configured to include an information verification screen (1510), a supporting post (1520), an information inputting screen (1530), and an information outputting unit (1535), and a total of four display devices are aligned.

Herein, the information verification screen (1510) may output information on air freight based upon information that is inputted by the user through the information inputting screen (1530) or information that is inputted by the user through the mobile device.

Meanwhile, the information verification screen (1510) may provide convenience to the user in verifying information by being capable of moving along the direction of the arrow, i.e., moving vertically.

As shown in FIG. 4, the information inputting screen (1530) may be provided in the form of an interface, or any one of the flight information shown in FIGS. 5 to 14 may be provided on the corresponding screen.

Diverse types of offline advertisements including the airport title may be provided on the supporting post (1520).

The information outputting unit (1535) may output air freight information whenever required by the user.

The display device may not only be capable of quickly and easily inputting user information through a proximity sensor (or NFC) or a tag or through a barcode or QR code reader, which can read the tickets, without having to perform any separate input, but the display device may also be capable of easily accessing air freight information by performing a simple touch or click.

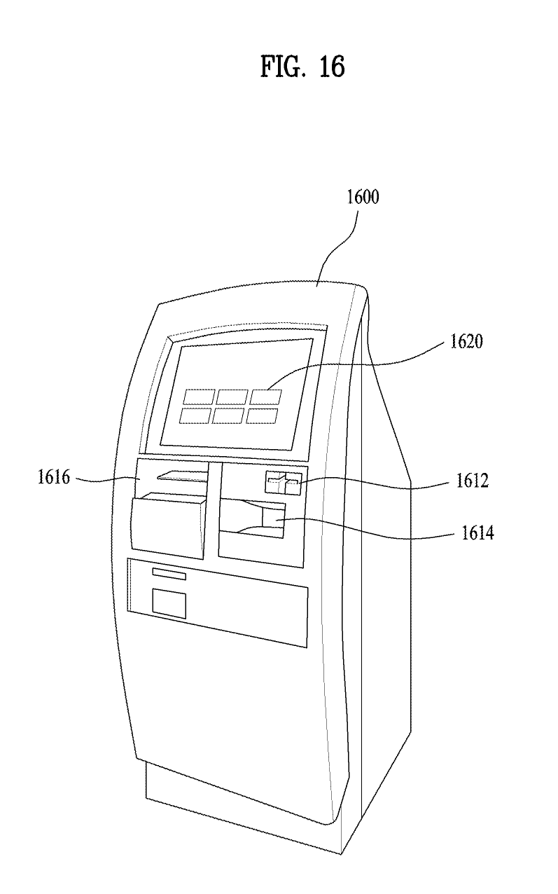

Referring to FIG. 16, the display device (1600) is configured to include an identification unit and an information verification screen (1620).

Herein, the identification unit includes a credit card or user ID card identifier (1612), a code recognition device (1614) for identifying barcodes or QR codes that are printed on the user's ticket, a recognition device (1616) for identifying passports or fingerprints, and by identifying personal information of the user, the identification unit may map the identified information to the flight information or ticket information.

Information for receiving air freight of the corresponding user may be outputted to the information verification screen (1620) through the mapped information through the identification unit, and, accordingly, the user may receive his (or her) air freight.

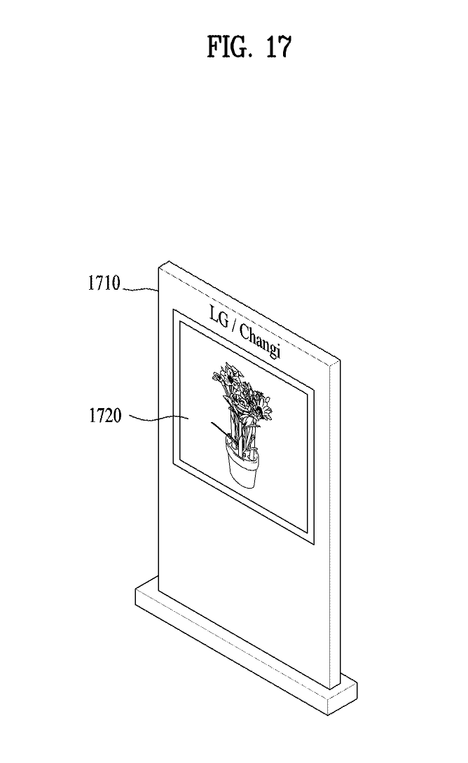

FIG. 17 may correspond to a display device, which is installed in diverse locations within the airport, the corresponding display device may be installed, or the display device may include an identifier (1710) for identifying the airport, and so on, and an information providing screen (1720) providing information.

Meanwhile, as described above, for example, the information providing screen (1720) may provide flight information or advertisement information, and, herein, the flight information may correspond to one of the flight information described in FIGS. 4 to 16.

Being configured to have a similar configuration as the above-described FIGS. 8 to 9, FIG. 18 may be configured as a display device (1800) that is entirely touchable, and, therefore, without having to be equipped with a separate inputting means, all information including the flight information may be configured and verified by touching the information providing screen (1810, 1820).

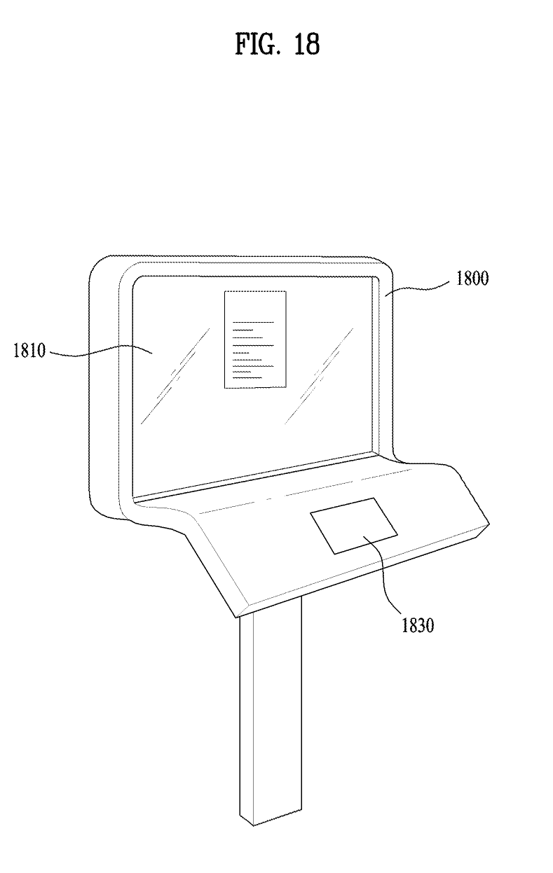

As described in FIG. 17, the information providing screen (1810, 1820) of FIG. 18 may also correspond to one of the flight information described in FIGS. 4 to 16.

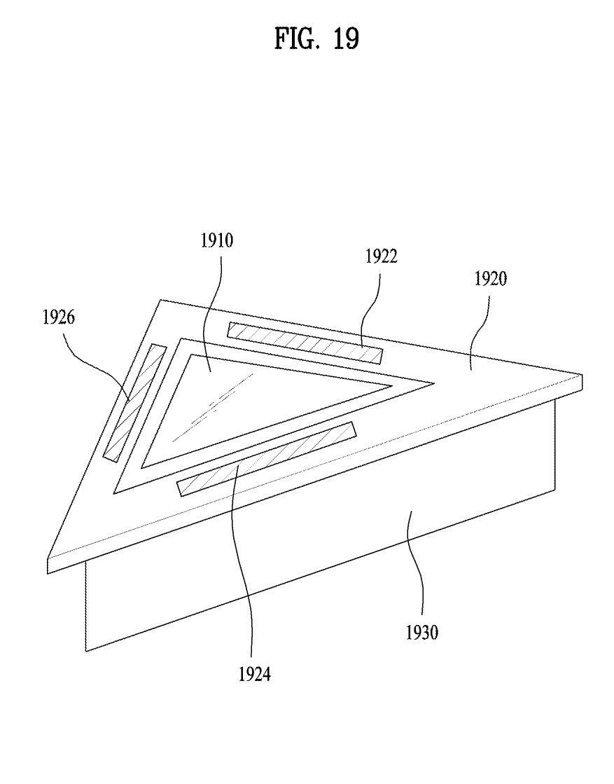

FIG. 19 corresponds to a display device having another form, and by being configured to have a polygonal shape, such as a triangle, multiple users may be capable of using the display device at the same time.

As described above, when the display device is configured to have a polygonal shape or a cylindrical shape or a cone-shape, as shown in FIG. 19, not only can the spatial efficiency can be enhanced, but multiple users may be capable of using the device at the same time, and, as shown in FIG. 19, the airport title or tour information or advertisement information may be provided in the common section (1910), thereby enhancing its effect.

Meanwhile, as shown in other drawings, an information verification screen is provided on an individual section (1920), which is located at the edge of the display device, so that air freight information can be displayed.

Additionally, when providing information in a 3D format or in a holographic format, since the common section (1910) and the individual section (1920) may attract the attention of the users, theirs effects may be maximized.

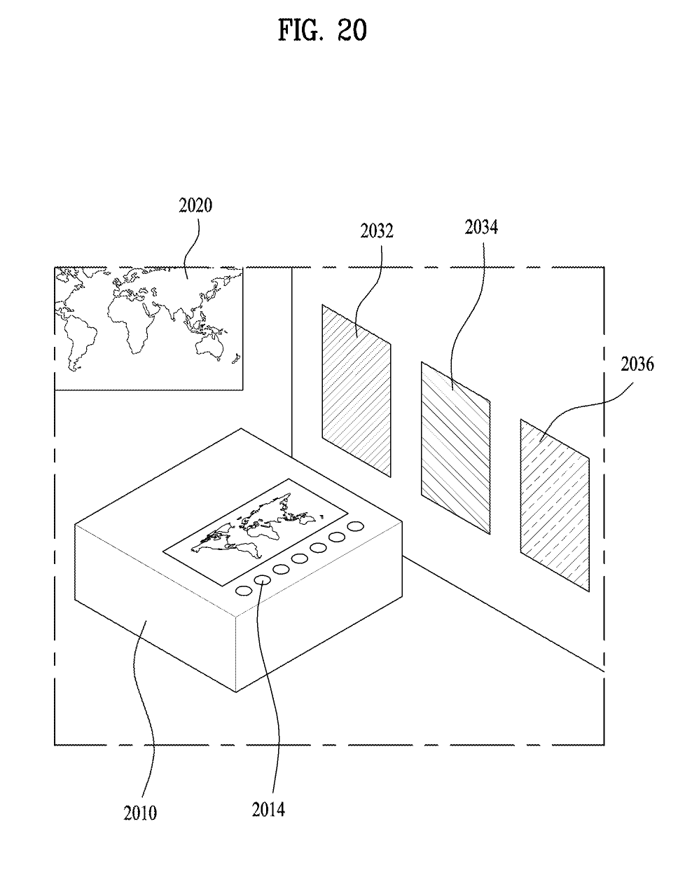

As described above in FIG. 19, FIG. 20 illustrates an exemplary embodiment of display devices being positioned to be adjacent to one another so that multiple users can user the display device at the same time.

For example, a first display device (2010) is configured as a table format and is equipped with a predetermined inputting device (2014) along with an information verification screen.

A second display device (2020) is provided in the above-described map information format, which can be accessed by touch.

Meanwhile, third to fifth display devices (2032 to 2036) may also correspond to display devices that can be accessed by the user via individual touch.

Additionally, the second to fifth display devices may provide information related to the corresponding information or detailed information in accordance with the first display device (2010).

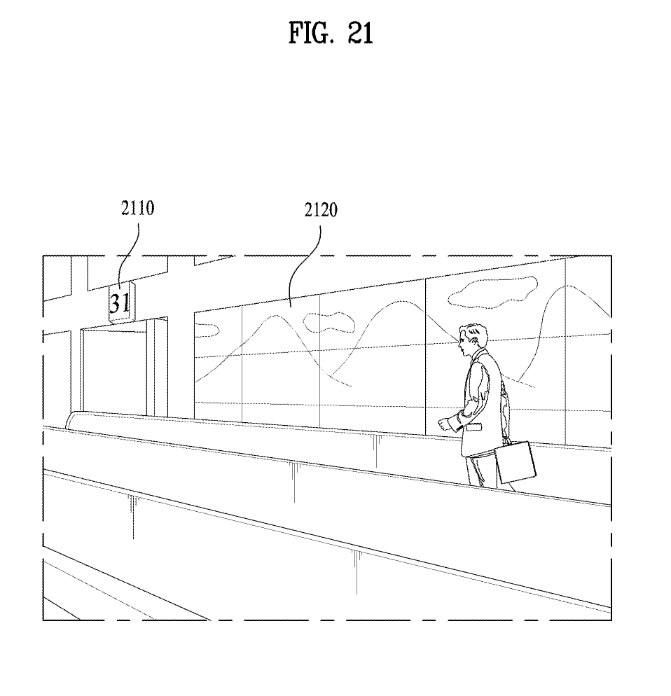

FIG. 21 illustrates an exemplary embodiment of yet another display device, which can provide an information providing screen (2120) on its side surface along with gate identification information (2110), so that airport users can use flight information or other additional information, such as advertisement information, during a process of moving within/outside of the airport.

Additionally, in flight information of FIGS. 4 to 21, or in a display device through which the flight information is being provided, audio may also be recognized, thereby allowing viewing impaired users or users having difficulty using their hand(s) to easily control the information or device.

Additionally, link may be established through wired/wireless communication networks, such as LTE (Long Term Evolution), Wi-Fi, ZigBee, RS-232, RS-485 or Bluetooth, LAN (Local Area Network), and so on, which are mostly used in mobile devices, and information that is identical to the information being outputted to the information verification screen may be converted in accordance with the corresponding communication protocol and then provided to the connected mobile device.

Meanwhile, the flight information of FIGS. 4 to 21 or the display device through which the flight information is being provided may be controlled by the user via his (or her) touch. However, the control may also be performed indirectly through the mobile device.

The flight information disclosed in FIGS. 8 to 21 may be configured, for example, of at least any one of FIGS. 4 to 7 or a combination of two or more of the above.

Additionally, although it is not shown in the drawing, as shown in FIG. 8, all processes including ticketing and other entry/departure related procedures may be processed through the flight information, which is being provided in real-time through the above-described display device being installed in various locations within the airport, without having to wait in a waiting line, and without having to visit a location specified for procedures, such as ticketing, which is processed by manpower,

Moreover, the display device of FIGS. 4 to 21 may provide current processing status of flight information in the form of a 3D map, so that the user can easily view the information at one glance, and, as in the above-described screen configuration, information on the time remaining until the scheduled flight, information on reservation, and so on, may also be provided and set up. In case the reservation is set up separately, information on reservation time, reservation payment, and so on, and information on all other expenses that are required for the process of using the airport may be provided and the respective payment may also be processed.

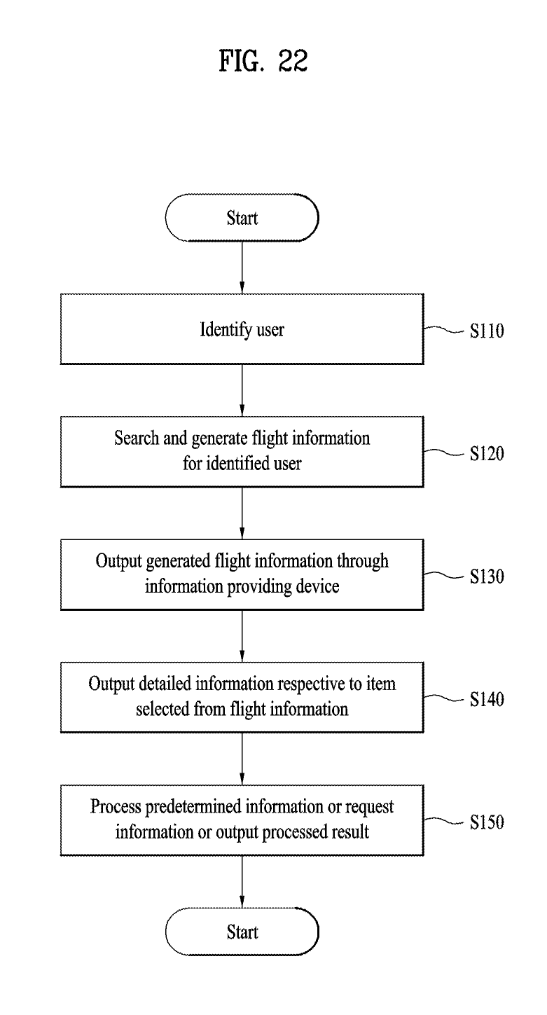

FIG. 22 illustrates an exemplary flow chart for describing a signal processing method for processing air freight within an information providing system.

An example of a method for providing flight information, which is disclosed in this disclosure, includes identifying an airport user, generating flight information for the identified airport user and outputting the generated information through an information providing device, receiving a predetermined item or an information request signal within the provided flight information, and outputting a processed result in accordance with the received item or information request signal through the information providing device, wherein the flight information provides visual information respective to entry and departure and airplane flight information linked to the visual information in at least one format of a map, a graph, and a three-dimensional (3D) display, and wherein the information providing device includes at least one of a mobile device of the identified air user and a previously installed in-airport display device.

Meanwhile, as described above, the flight information may further include at least one of entry and departure information, air freight information, advertisement information, and route information, and the flight information may be automatically aligned a selected item based on at least one of point of departure, point of arrival, time information, airline information, and continent information, and marked differently the selected item from other items by at least one of color and size or to be highlighted, and the flight information may be displayed multiple sets of flight information on a display screen of the mobile device or information providing device, each of the multiple sets of flight information being configured to have a different format.

Additionally, as described above, the multiple sets of flight information may be sequentially modified or aligned in accordance with an access to any one set of flight information being related to one another.

The step of receiving a predetermined item or an information request signal within the provided flight information may be performed by a touch input of the information providing device or through a flight information application within the mobile device of the identified user, and the step of identifying an airport user may be performed on least one of an identification including a passport, a plane ticket, and a mobile device being registered in advance through at least one of a barcode reader, a Quick Response (QR) code reader, and a proximity sensor.

When a user enters an airport, the system for providing flight information identifies a user from its entrance or through diverse display devices (S110).

Thereafter, the system for providing flight information searches for and generates flight information for the identified user (S120). At this point, for example, flight reservation information or registration information respective to the identifier may be searched in advance, so that flight information that is to be provided to the user can be generated based upon the searched flight reservation information or registration information.

Subsequently, the system for providing flight information outputs the generated flight information through an information providing device (S130).

The system for providing flight information outputs detailed information on an item that is selected from the flight information, which is outputted through the information providing device (S140).

Processing of predetermined information or information requested by the user and/or the processing result may be provided from the flight information, such as the outputted detailed information (S150).

Moreover, in case of diverse difficulty situations wherein immediate or real-time processing cannot be carried out due to an error occurring in each of the above-described flight information or display device, or due to the information being insufficient or inadequate to be displayed, and so on, for example, the present invention may also be implemented so that related information can be provided or directly connected through the flight information system control unit (110) of FIG. 1 and/or the system management unit (160), so that processing can be carried out.

Additionally, as described above, although each drawing illustrates an individual exemplary embodiment, the exemplary embodiments disclosed in at least two or more drawings may be combined to configure a new exemplary embodiment.

### Mode for Carrying Out the Present Invention

The diverse exemplary embodiments of the preset invention have all been described in its best mode for carrying out the present invention.

According to the present invention, which is described above, the flight information may be accurately and intuitively provided to the airport users in real-time, and, by providing map based or position information based map information along with the flight information, the airport users may be capable of efficiently using a maximum amount of time and space within the airport. Additionally, according to the present invention, by providing flight information and map information, the airport users may be prevented from experiencing unnecessary complicated procedures within the airport upon their departure or arrival as much as possible, and, by improving the level of satisfaction is using the airport, the present invention has an advantageous effect of realizing an indirect effect of promoting airport sales revenue by improving the airport impression (or image) and by increasing advertisement effect targeting the airport users.

### INDUSTRIAL APPLICABILITY

The exemplary embodiments described in this disclosure relate to a display device being used in airports, and so on, and, since the exemplary embodiment described herein can be used in all digital industrial sites where such display devices can be used, the present invention is industrially applicable.

What is claimed is:

1. A system for providing flight information, comprising:
a control unit identifying an airport user, controlling to generate and provide flight information to the identified airport user, receiving a predetermined item or an information request signal within the provided flight information, and controlling a processing corresponding to the received item or information request signal; and
an information providing device outputting the flight information and processed results corresponding to the request signal,
wherein the control unit controls to provide flight information including visual information respective to entry and departure and airplane flight information linked to the visual information in at least one format of a map, a graph, and a three-dimensional (3D) display, and
wherein the information providing device includes at least one of a mobile device of the identified airport user and a previously installed in-airport display device.

2. The system of claim 1, wherein the control unit performs control to generate the flight information further including at least one of entry and departure information, air freight information, advertisement information, and route information.

3. The system of claim 2, wherein the control unit controls a selected item to be automatically aligned based on at least one of point of departure, point of arrival, time information, airline information, and continent information, and the selected items to be marked differently from other items by at least one of color and size or to be highlighted.

4. The system of claim 1, wherein the control unit identifies a user by sensing at least one of an identification including a passport, a plane ticket, and a mobile device through at least one of a barcode reader, a Quick Response (QR) code reader, and a proximity sensor.

5. The system of claim 1, wherein, if the information providing device corresponds to a mobile device of the identified airport user, and a flight information application is not installed in the mobile device, the control unit controls the flight information application to be downloaded.

6. The system of claim 1, wherein, if the information providing device corresponds to the previously installed in-airport display device, the control unit receives and processes the request signal through a touch input.

7. The system of claim 1, wherein the control unit controls multiple sets of flight information to be simultaneously outputted, each of multiple sets of flight information being configured to have a different format, to a display screen of the information providing device.

8. The system of claim 7, wherein, if any one of the multiple sets of flight information is accessed, the control unit controls other flight information being related to a request made by the accessed flight information to be outputted by being sequentially modified or aligned.

9. A method of providing flight information, the method comprising:
identifying an airport user;
generating flight information for the identified airport user and outputting the generated information through an information providing device;
receiving a predetermined item or an information request signal within the provided flight information; and
outputting a processed result in accordance with the received item or information request signal through the information providing device,
wherein the flight information provides visual information respective to entry and departure and airplane flight information linked to the visual information in at least one format of a map, a graph, and a three-dimensional (3D) display, and
wherein the information providing device includes at least one of a mobile device of the identified air user and a previously installed in-airport display device.

10. The method of claim 9, wherein the flight information further includes at least one of entry and departure information, air freight information, advertisement information, and route information.

11. The method of claim 10, wherein the flight information is automatically aligned a selected item based on at least one of point of departure, point of arrival, time information, airline information, and continent information, and marked differently the selected item from other items by at least one of color and size or to be highlighted.

12. The method of claim 11, wherein the flight information are displayed multiple sets of flight information on a display screen of the mobile device or information providing device, each of the multiple sets of flight information being configured to have a different format.

13. The method of claim 12, wherein the multiple sets of flight information are sequentially modified or aligned in accordance with an access to any one set of flight information being related to one another.

14. The method of claim 9, wherein the step of receiving a predetermined item or an information request signal within the provided flight information is performed by a touch input of the information providing device or through a flight information application within the mobile device of the identified user.

15. The method of claim 9, wherein the step of identifying an airport user is performed on least one of an identification including a passport, a plane ticket, and a mobile device being registered in advance through at least one of a barcode reader, a Quick Response (QR) code reader, and a proximity sensor.
